(19) United States
(12) Patent Application Publication
(10) Pub. No.: US 2020/0342288 A1
(43) Pub. Date: Oct. 29, 2020

(54) DIRECT COMPUTATION WITH COMPRESSED WEIGHT IN TRAINING DEEP NEURAL NETWORK

(71) Applicant: Microsoft Technology Licensing, LLC, Redmond, WA (US)

(72) Inventors: Jinwen Xi, Sunnyvale, CA (US); Bharadwaj Pudipeddi, San Jose, CA (US)

(21) Appl. No.: 16/584,711

(22) Filed: Sep. 26, 2019

Related U.S. Application Data
(60) Provisional application No. 62/837,627, filed on Apr. 23, 2019.

(51) Int. Cl. G06N 3/04; G06K 9/62; G06F 17/16

(52) U.S. Cl. CPC G06N 3/04; G06F 17/16; G06K 9/6218

(57) ABSTRACT

A distributed training system including a parameter server is configured to compress the weight metrices according to a clustering algorithm, with the compressed representation of the weight matrix may thereafter distributed to training workers. The compressed representation may comprise a centroid index matrix and a centroid table, wherein each element of the centroid index matrix corresponds to an element of the corresponding weight matrix and comprises an index into the centroid table, and wherein each element of the centroid table comprises a centroid value. In a further example aspect, a training worker may compute an activation result directly from the compressed representation of a weight matrix and a training data matrix by performing gather-reduce-add operations that accumulate all the elements of the training data matrix that correspond to the same centroid value to generate partial sums, multiplying each partial sum by its corresponding centroid value, and summing the resulting products.

### CROSS-REFERENCE TO RELATED APPLICATIONS

This application claims priority to U.S. Provisional Patent Application No. 62/837,627, filed Apr. 23, 2019, titled “Direct Computation with Compressed Weight in Training Deep Neural Network,” the entirety of which is incorporated by reference herein.

### BACKGROUND

A deep neural network (DNN) is an artificial neural network (ANN) with multiple layers between the input and output layers. Recently, the trend has been towards DNNs with ever increasing size, and current DNNs may be characterized by millions of parameters each represented in 32-bit floating point data format. Training such DNNs can be challenging since it may be difficult or impossible to achieve scalable solutions. Typical solutions seek to exploit data, model and/or data-model parallelism by utilizing multiple training workers, each working in parallel with the others. Systems implementing such solutions may utilize training workers that are logically and/or physically separated and are typically referred to as distributed training systems.

A distributed training system typically functions through a central server (or servers) responsible for dividing the training problem into discrete jobs, each suitable for computation by a single training worker. Each job is thereafter distributed to a worker for computation, with the worker sending a compute result back to the server upon completion. A distributed training system allows compute power to scale easily since adding compute power requires only the addition of more training workers. However, the communication bandwidth required to coordinate the activity of numerous training workers does not scale at the same pace.

Data compression techniques may be applied to the communications between the system server and training workers in order to reduce the overhead and improve scalability. While data compression helps reduce the communication overhead and reduce bandwidth requirements, each worker is further tasked with decompressing received data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for greater efficiency in the training of deep neural networks and in the generation of inferences by deep neural networks. In an example aspect, a parameter server and a plurality of training workers are provided wherein training workers are configured to perform training directly with compressed weight representations. In a further aspect, 1) the parameter server initializes weight matrices and generates compressed representations thereof; 2) each worker receives training data (i.e., DNN input data used for training purposes as opposed to generating inferences) and compressed representation(s) of a weight matrix and calculates gradient matrices using forward and backward paths, 3) each worker transfers the calculated gradient matrices back to the parameter server which updates the global weight matrices, 4) the parameter server compresses the updated global weight matrices and transfers them to each worker, 5) each training worker restarts at 2) with new training data and calculates gradient matrices until the loss converges, and does so directly using the received compressed matrices.

In a further example aspect, the parameter server is configured to compress the weight metrices according to a clustering algorithm whereby weight values in a weight matrix are grouped into clusters wherein the cluster centroid may thereafter represent the weight of each element in that cluster. A compressed representation of a weight matrix may thereafter be distributed to training workers.

In another example aspect, a compressed representation of a weight matrix may comprise a centroid index matrix and a centroid table, wherein each element of the centroid index matrix corresponds to an element of the corresponding weight matrix and comprises an index into the centroid table, and wherein each element of the centroid table comprises a centroid value.

In a further example aspect, a training worker may compute an activation result directly from a compressed representation of a weight matrix and a training data matrix by performing gather-reduce-add operations that accumulate all the elements of the training data matrix that correspond to the same centroid value to generate partial sums, multiplying each partial sum by its corresponding centroid value, and summing the resulting products.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a block diagram of an example distributed training system including a parameter server including a weight compressor, and training workers including direct activation result calculators, according to an embodiment.

FIG. 2 depicts a detailed schematic view of an example weight compressor, according to an embodiment.

FIG. 3 depicts a schematic view of an example weight matrix and a corresponding example compressed representation of the weight matrix, according to an embodiment.

FIG. 4 depicts a detailed block diagram view of an example training worker containing an example direct activation result calculator, according to an embodiment.

FIG. 5 depicts a diagram illustrating a process flow for generating an activation result directly from a compressed representation, according to an embodiment.

FIG. 6 depicts a flowchart of an example method for generating an activation result directly from the compressed representation of a weight matrix, according to an embodiment.

FIG. 7 depicts a flowchart of a refinement to the flowchart of FIG. 7 including an example compressed representation implementation, according to an embodiment.

FIG. 8 depicts a flowchart of a refinement to the flowchart of FIG. 8 for generating a plurality of partial sums, according to an embodiment.

FIG. 9 depicts a flowchart of a refinement to the flowchart of FIG. 9 including an example implementation for generating a set of products, according to an embodiment.

FIG. 10 depicts an example artificial neuron suitable for use in a deep neural network (“DNN”), according to an embodiment.

FIG. 11 depicts an example DNN composed of artificial neurons, according to an embodiment.

FIG. 12 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Modern deep neural network (“DNN”) features millions/billions of parameters and advanced systems are generally required to train such a DNN model. Typically, one may employ a distributed training system to train such DNNs. As mentioned above, distributed training systems ideally allow for scaling of both compute power and communication bandwidth. Weight compression effectively increases the communication bandwidth by packing the original weight matrices into fewer bits. However, a training worker needs to spend cycles to decompress the weight data from the compressed format before starting the forward/backward computation. Moreover, use of a full-size, decompressed weight matrix offers no advantages to training workers that may be memory constrained. Direct computation with a compressed representation of the weight matrix requires fewer cycles than the combination of decompression and subsequent computation, and also reduces the memory requirement for each training worker.

Accordingly, embodiments enable improved efficiency in the training of deep neural networks and in the generation of inferences by deep neural networks. In an embodiment, a weight matrix may be compressed by clustering weight matrix elements into a constant K number of clusters, with the cluster centroid serving as an approximation for each matrix element falling into that cluster. In one embodiment, the compressed representation of the weight matrix includes a bin index matrix equivalent in size to the corresponding weight matrix, and a table of K centroids. Each element of the bin index matrix includes an index value of log 2(k) format that indexes into the centroid table. Upon the reception of the above described compressed representation of the weight matrix, as well as a matrix of training values, a training worker performs a gather-reduce-add by searching all the elements of the training matrix for elements corresponding to the same centroid to generate a partial sum. The K partial sums are subsequently multiplied with the cluster centroid value and accumulated to generate the activation result used to calculate the forward/backward paths.

Embodiments advantageously avoid having to decompress the compressed representation into a weight matrix of full precision values, and moreover, calculation of an activation result need not perform the N\hat{ }2 floating point multiplications required to compute the dot product of the decompressed weight matrix and the training data. Likewise, and as is described in greater detail herein below, because the weight matrix is only stored in compressed format, significant memory savings may be enjoyed.

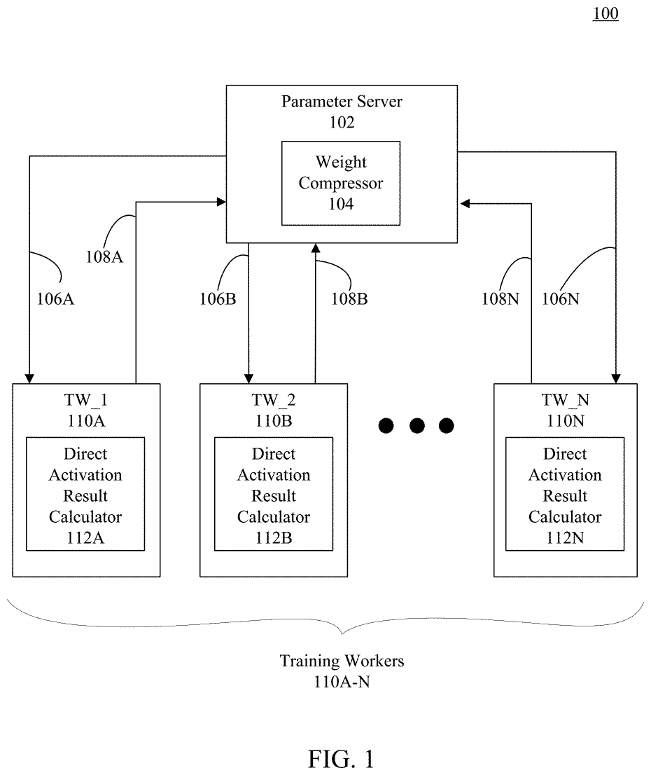

Embodiments for training deep neural networks in this manner may be implemented in various ways. For instance, FIG. 1 depicts a block diagram of an example distributed training system 100, according to an embodiment. System 100 includes a parameter server 102 and a plurality of training workers 110A-110N. Parameter server 102 includes a weight compressor 104. Each training worker 110A-110N includes a direct activation result calculator 112A-112N, respectively. Other structural and operational embodiments will be apparent to person skilled in the relevant art(s) based on the following discussion regarding distributed training system 100 as depicted in FIG. 1.

Any number of training workers 110A-110N may be present, including numbers in the ones, tens, hundreds, millions, and even greater numbers. In an embodiment, distributed training system 100 may comprise a networked system of multiple computers and/or processors, including tens, hundreds, thousands, and even greater numbers of computers and/or processors. It should be understood, however, that embodiments may also comprise a collection of logical compute resources that may or may not be physically distributed in the ordinary sense. Moreover, although depicted in FIG. 1 as a discrete server, it should be understood that parameter server 102 may comprise other types of computing devices. For example, parameter server 102 may comprise a server, a server set, or one more other computing devices capable of training a DNN, such as a computing device or set of computing devices including multiple computers and/or multiple processors. Likewise, training workers 110A-110N may each comprise or include multiple processors and/or processing units, such as in the form of one or more GPUs (graphics processing unit), FPGAs (field programmable gate array), ASICs (application specific integrated circuit), and/or other processor(s). The general operation of an embodiment of distributed training system 100 is further described as follows.

Distributed training system 100 operation is controlled by parameter server 102 which operates in conjunction with each of training workers 110A-110N in the following general manner. First, DNN weights in an untrained model are initialized. As understood in the art, weights are typically initialized to values selected to avoid issues with exploding or vanishing gradients, depending on the chosen activation function. In an embodiment, weight values may be initialized at least in part based upon a random seed, and each of parameter server 102 and training workers 110A-110N may initialize their weight matrices according to the same random seed. In such an instance, parameter server 102 is not required to distribute a copy of the initialized weight matrices to each of training workers 110A-110N. It should be understood, however, that in other embodiments, parameter server 102 may be configured to wholly control initialization of the global weight matrices, and to distribute compressed versions thereof to training workers 110A-110N.

Thereafter, parameter server 102 may distribute training data and compressed weight matrices 106N to each of training workers 110A-110N which may thereafter perform training in conjunction with parameter server 102 by performing the following steps: 1) compute forward propagation using training data, and the initialized weight matrix, 2) compute the loss function, 3) perform backward propagation by calculating the gradients of the loss function in the reverse direction through the DNN, 4) transfer gradients 108N back to parameter server 102 which in turn updates the global weights, 5) weight compressor 104 of parameter server 102 compresses the updated global weight matrices and transfers the compressed representation to each of training workers 110A-110N (e.g., as part of training data and compressed weight matrices 106N), 6) each of training workers 110A-110N decompresses the compressed representation of the weight matrix to its original form, and 7) restart back at 1) until the computed loss function converges.

In an embodiment, decompressing the compressed representation of the weight matrix to its original form at training step 6) is omitted, and steps 1), 2) and 3) are performed using the compressed representation directly. This technique not only increases the effective bandwidth by transferring only compressed weight matrices, but also reduces the effective model size and computation FLOPs (floating point operations) for each worker without significant loss of accuracy when performing forward/backward path on the compressed weight matrices directly.

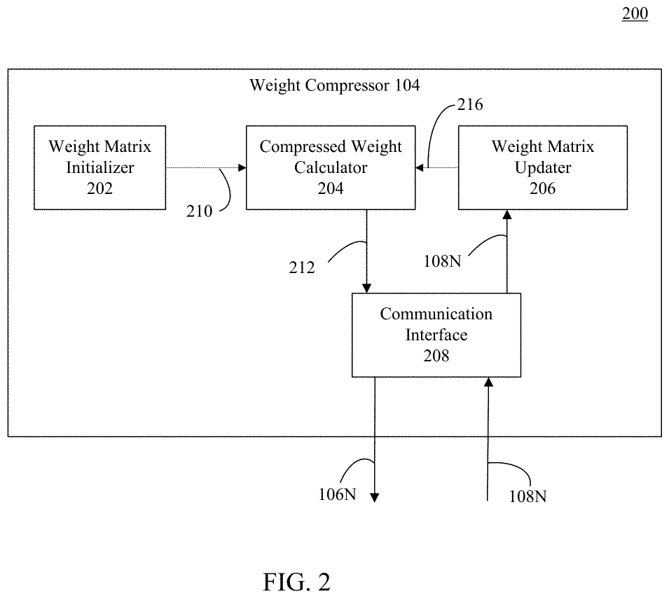

Compression of weight matrices may be performed in various ways. For example, FIG. 2 depicts a detailed schematic view of an example of weight compressor 104 of FIG. 1, according to an embodiment. In FIG. 1, weight compressor 104 includes a weight matrix initializer 202, a compressed weight calculator 204, a weight matrix updater 206 and a communication interface 208. Other structural and operational embodiments will be apparent to persons skilled in the relevant art(s) based on the following discussion regarding weight compressor 104 as depicted in FIG. 2.

As described above, prior to training the weights of the DNN must be initialized to a suitable value as understood in the art. In an embodiment, and with continued reference to distributed training system 100 of FIG. 1, weight matrix initializer 202 may be configured to initialize the weights of the global weight matrices 210 according to an initialization heuristic depending on the chosen loss function, and provide same to compressed weight calculator 204. For example, a Xavier initialization may be employed where the chosen loss function is tan h(z).

Compressed weight calculator 204 may accept global weight matrices 210 as depicted in FIG. 2, or may also accept updated global matrices 216 as is described in further detail below. In either case, embodiments of compressed weight calculator 204 may be configured to perform weight compression on the received weight matrices to generate compressed representations 212. For example, in an embodiment, weight compression may be accomplished by grouping the elements of each weight matrix into K clusters, wherein the cluster centroid represents the weight for each such element in that cluster. For example, assume the weight matrices are reshaped into a M-by-1 vector [w1; w2; . . . , wM] and wᵢ∈ [symbol] , and the M elements are clustered into K bins. ci is the index of cluster (1, 2, . . . , K) to which element wi is assigned. μk is the cluster centroid k (uₖ∈ [symbol] ). The weight compression performs the following optimization algorithm:

$$J ( {c}_{1} , {c}_{2} , … {c}_{M} , {μ}_{1} , {μ}_{2} , … , {μ}_{K} ) = \frac{1}{M} {\sum }_{i = 1}^{M} {‖ {w}_{i} - {μ}_{{c}_{i}} ‖}^{2} \\ {min}_{{c}_{1} , {c}_{2} , … , {c}_{M} , {μ}_{1} , {μ}_{2} , … , {μ}_{K}} J ( {c}_{1} , {c}_{2} , … , {c}_{M} , {μ}_{1} , {μ}_{2} , … , {μ}_{K} ) \qquad ( eq . 1 )$$

Returning to FIG. 2, compressed weight calculator 204 may be configured to provide compressed representation 212 to communication interface 208 for subsequent transmission to one or more training workers 110A-110N (e.g., as part of training data and compressed weight matrices 106N). As described above, training workers 110A-110N are configured to transfer computed gradients 108N back to parameter server 102. As depicted in FIG. 2, gradients 108N may be received by communication interface 208 of weight compressor 104, and subsequently provided to weight matrix updater 206. Weight matrix updater 206 may be configured to update the global weights, and provide updated weight matrices 216 to compressed weight calculator 204 for generation of compressed representations 212 as described above.

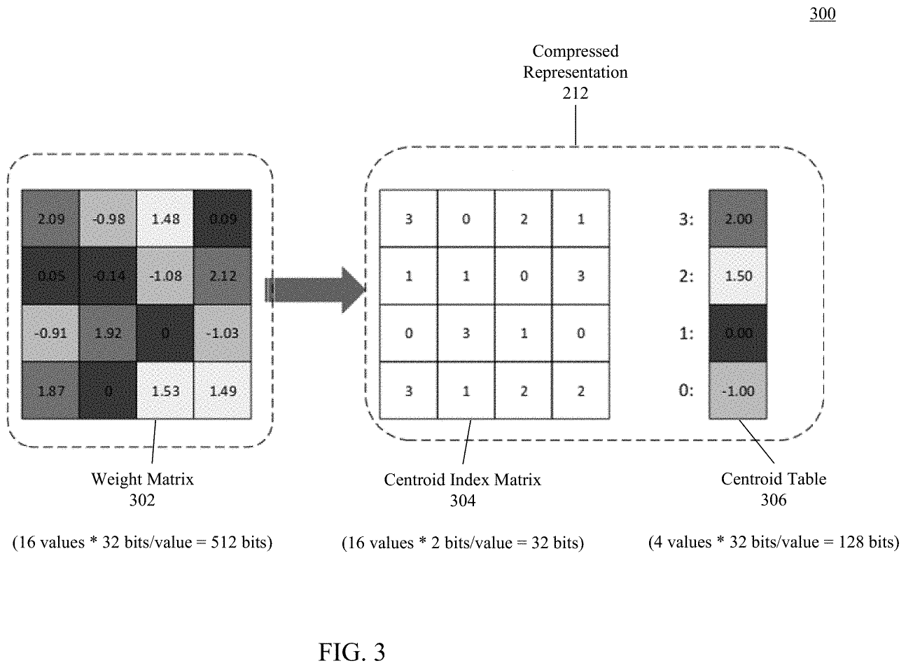

In an embodiment, each of compressed representations 212 generated by compressed weight calculator 204 per the above described algorithm comprises (1) a K-entry look-up table with the K cluster centroids, and (2) a matrix with the same shape as the weight matrix but reduced number of bits of log₂(K) to represent each element. For example, consider FIG. 3 that depicts a schematic view 300 an example weight matrix 302 and a corresponding example compressed representation 212 of weight matrix 302, according to an embodiment. Weight matrix 302 is a simplified 4×4 matrix comprising DNN layer weights. Each of the 16 elements of weight matrix 302 is a 32-bit floating point value. Accordingly, weight matrix 302 requires 512 bits of storage.

Compressed representation 212 includes a centroid index matrix 304 and a centroid table 306. In this example, centroid table 306 is the K-entry look-up table, and centroid index matrix 304 is the reduced bit representation of the corresponding weight matrix each as described herein immediately above. Embodiments of compressed weight calculator 204 may be configured to apply the above described algorithm to weight matrix 302 to cluster its elements into K bins. In the example compressed representation of FIG. 3, K=4. That is, the elements of weight matrix 302 are collected into clusters wherein the elements of each cluster correspond to the calculated centroid value for that cluster. In this example, the centroid value is the mean of the values of the elements of that cluster, and the centroid values are determined such that the sum-of-squares of cluster values is minimized.

Centroid table 306 includes the K=4 centroid values corresponding to each cluster. Each centroid value is associated with a lookup key 0-3. Centroid index matrix 304 is a 4×4 matrix containing the lookup key for the appropriate centroid value in centroid table 306 for the corresponding element of weight matrix 302. Accordingly, centroid index matrix 304 illustrates which elements of weight matrix 302 are approximated by the corresponding centroid value. Thus, for example, each element of centroid index matrix 304 that is a ‘1’ maps to a corresponding element in weight matrix 302 that is best approximated by the centroid value corresponding to a lookup key of ‘1’ in the centroid table. It will be appreciated, therefore, that compressed representation 212 corresponds to an approximation of weight matrix 302, but with reduced storage requirements. In particular, each element of centroid index matrix 304 requires 2 bits per elements (i.e., 32 bits), and each element of centroid table 306 requires 32 bits per element (i.e., 128 bits) meaning that compressed representation 212 requires only 160 bits to store an approximation of weight matrix 302 which itself requires 512 bits.

Accordingly, distribution of compressed representation 212 to each of training workers 110A-110N requires only 160/512*100%=31.25% of the communications bandwidth as compared to weight matrix 302. Likewise, and as is described in detail herein below, training workers 110A-110N may compute activation results using compressed representation 212 directly, and without the need to expand compressed representation 212 thereby requiring less memory (e.g., in this example, only about 31% of the memory required by weight matrix 302).

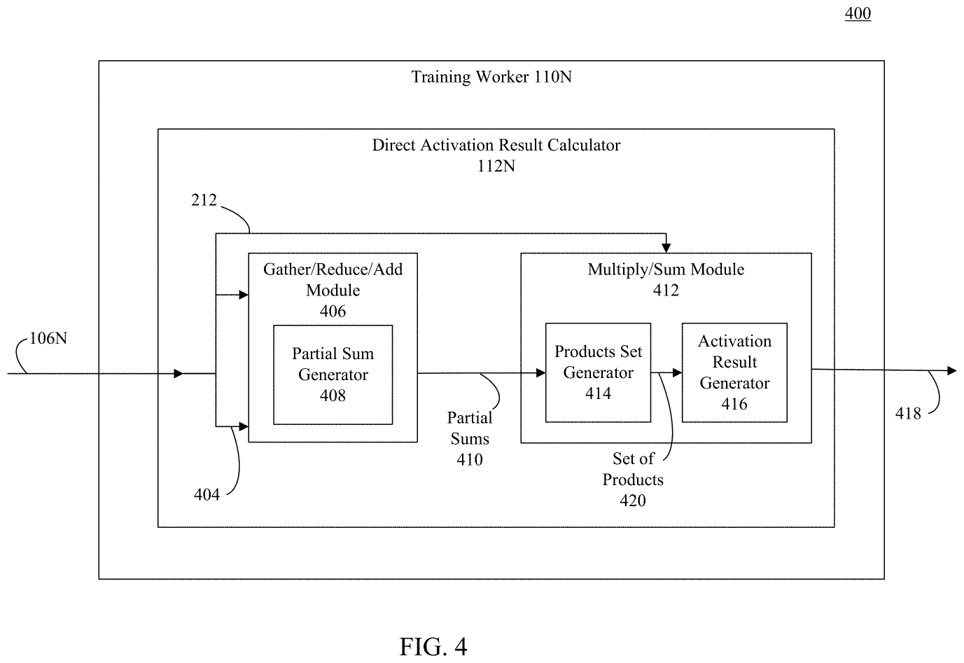

There are of course various ways to compute activation results directly from, for example, compressed representation 212. For example, as described briefly above, each of training workers 110A-110N may include an instance of direct activation result calculator 112 configured to perform such direct calculation without decompression. There are likewise various ways of implementing embodiments of direct activation result calculator 112. For example, FIG. 4. depicts a detailed schematic view of an example training worker 110B and example direct activation result calculator 112N, according to an embodiment. Direct activation result calculator 112N includes a gather/reduce/add module 406, a multiply/sum module 412, a products set generator 414, and an activation result generator 416. Other structural and operational embodiments will be apparent to person skilled in the relevant art(s) based on the following discussion regarding direct activation result calculator 112N as depicted in FIG. 4.

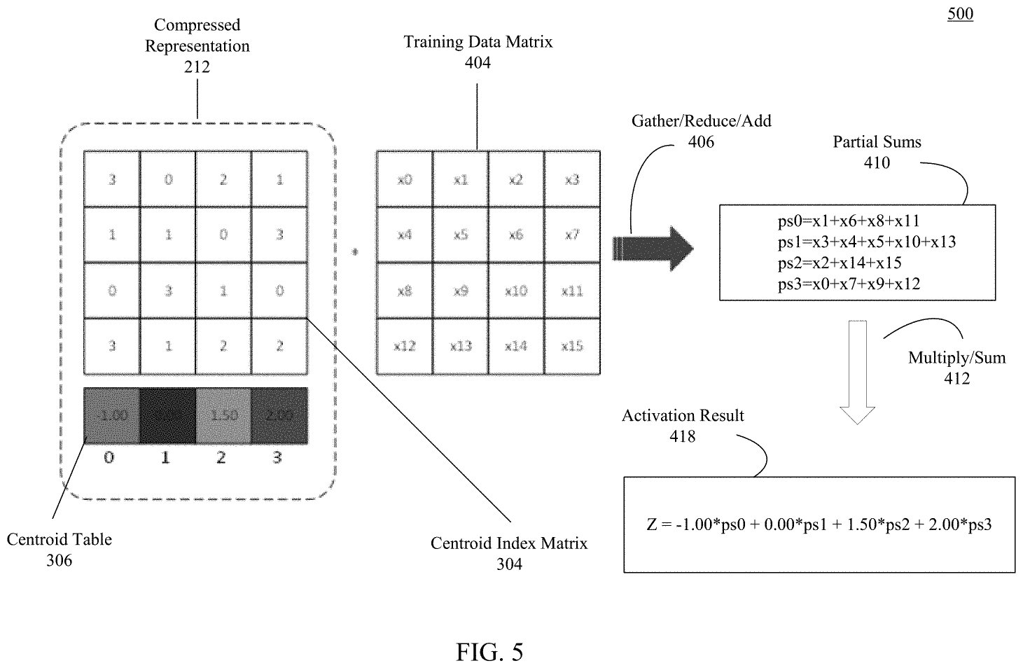

A high-level overview of the operation of direct activation result calculator 112N of training worker 110N, as shown in FIG. 4, and its thereafter operation are described in greater detail in the context of FIG. 5 which depicts a diagram illustrating an activation result 418 generated directly from compressed representation 212 and a training data matrix. As described above, parameter server 102 may be configured to distribute training data and compressed weight matrices 106N to each of training workers 110A-110N. As shown in FIG. 4, direct activation result calculator 112N may be configured to receive training data and compressed weight matrices 106N and to generate activation result 418 therefrom.

In an embodiment, direct activation result calculator 112N may be configured to split training data and compressed weight matrices 106N into constituent components. Namely, training data and compressed weight matrices 106N may be split into training data matrix 404 and compressed representation 212, each being available to gather/reduce/add module 406 for generation of partial sums 410 as is described in further detail below. Partial sums 410 and compressed representation 212 are provided to multiply/sum module 412 for generation of activation result 418. More detailed operation of the embodiment of direct activation result calculator 112N as depicted in FIG. 4 as is described as follows in the context of FIG. 5.

FIG. 5 depicts a diagram 500 illustrating a process flow for generating an activation result 418 directly from compressed representation 212, according to an embodiment. FIG. 5 includes compressed representation 212 as shown in FIG. 2, and an example training data matrix 404 as shown in FIG. 4. Compressed representation 212 includes centroid table 306 and centroid index matrix 304, also as described above.

Returning to FIG. 4, gather/reduce/add module 406 receives compressed representation 212 and training data matrix 404 and performs a gather/reduce/add operation whereby the elements of training data matrix 404 that correspond to the same centroid value as indicated by corresponding elements of centroid index matrix 304 are summed to generate partial sums 410. Thus, for example, each element of training data matrix 404 that corresponds to centroid index value 0 are summed to generate the partial sum ps0 as illustrated in FIG. 5. In particular, it can be seen in FIG. 5 that the elements of training data matrix 404 that correspond to a centroid index of 0 are: x1, x6, x8 and x11. Accordingly, the partial sum for centroid index 0 is the sum of those values, or x1+x6+x8+x11. Gather/reduce/add module 406 is configured to generate each of the remaining partial sums 410 as illustrated in FIG. 5 and reproduced herein below for convenience:

ps0=x1+x6+x8+x11

ps1=x3+x4+x5+x10+x13

ps2=x2+x14+x15

ps3=x0+x7+x9+x12

### Partial Sums 410 as Shown in FIG. 4

With reference to FIG. 4, multiply/sum module 412 is configured to accept compressed representation 212 and partial sums 410, and to generate activation result 418 therefrom. Multiply/sum module 412 is configured to multiply each sum of partial sums 410 by its corresponding centroid value in centroid table 306 to generate set of products 420. Multiply/sum module 412 is further configured to thereafter sum set of products 420 together, the sum being the activation result 418. For example, the partial sum for centroid index 0 as discussed above is: ps0=x1+x6+x8+x11, and the centroid value corresponding to centroid index 0 is −1.00 as shown in centroid table 306. Thus, the product corresponding to centroid index 0 is −1.00*ps0, and the set of products may be written as: {−1.00*ps0, 0.00*ps1, 1.50*ps2 and 2.00*ps3}. As mentioned above, activation result 418 is the sum of this set of products:

Z=−1.00*ps0+0.00*ps1=1.50*ps2+2.00*ps3

Activation result 418 may be generated and used in different ways depending on the operational context of the training algorithm. Generally speaking, activation result 418 may correspond to the output of a single hidden layer of the DNN, with such output being fed forward as input to the next layer in the DNN. On the other hand, activation result 418 may also represent a measure of output error of the DNN as such is being back propagated through the DNN, and to determine a corresponding gradient matrix for the DNN.

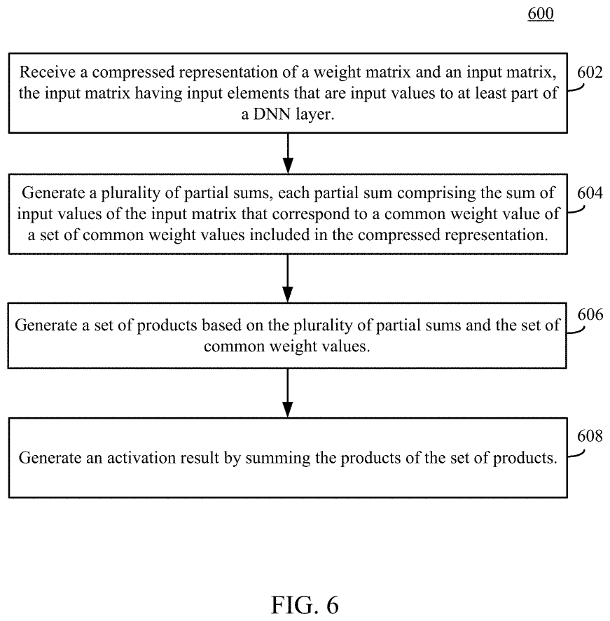

Further operational aspects of distributed training system 100 of FIG. 1, and parameter server 102 and training workers 110A-110N in particular, are described as follows in conjunction with FIG. 6. FIG. 6 depicts a flowchart 600 of an example method for generating an activation result directly from the compressed representation of a weight matrix, according to an embodiment. Flowchart 600 is described with continued reference to FIGS. 1, 2 and 4. However, other structural and operational embodiments will be apparent to persons skilled in the relevant art(s) based on the following discussion regarding flowchart 600 of FIG. 6 and distributed training system 100 of FIG. 1.

Flowchart 600 begins at step 602. At step 602, a compressed representation of a weight matrix and an input matrix are received, the input matrix having input elements that are input values to at least part of a DNN layer. For example, and with reference to training worker 110N as depicted in FIG. 4 and described above, direct activation result calculator 112N of training worker 110N is configured to accept training data and compressed weight matrices 106N from parameter server 102 via communication interface 208 of weight compressor 104. As discussed above, the training data matrix or matrices included in training data and compressed weight matrices 106N comprise training data that are input values for DNN layers. More specifically training data and compressed weight matrices 106N includes training data matrix 404 and compressed representation 212 as depicted in FIG. 4 and described above. Flowchart 600 of FIG. 6 continues at step 604.

In step 604, a plurality of partial sums is generated, each partial sum comprising the sum of input values of the input matrix that correspond to a common weight value of a set of common weight values included in the compressed representation. For example, and with reference to direct activation result calculator 112N of training worker 110N as depicted in FIG. 4 and as described in detail above, partial sum generator 408 of gather/reduce/add module 406 of direct activation result calculator 112N is configured to generate partial sums 410 by summing the elements of training data matrix 404 that correspond to the same centroid value as indicated by corresponding elements of centroid index matrix 304 of compressed representation 212. Flowchart 600 of FIG. 6 continues at step 606.

In step 606, a set of products is generated based on the plurality of partial sums and the set of common weight values. For example, and with reference to direct activation result calculator 112N of training worker 110N as depicted in FIG. 4 and as described in detail above, multiply/sum module 412 is configured to accept partial sums 410 from gather/reduce/add module 406, and provide same to products set generator 414 of multiply/sum module 412 to generate set of products 420. As described above, each of partial sums 410 is multiplied by its corresponding centroid value in centroid table 306 to generate set of products 420. Flowchart 600 of FIG. 6 concludes at step 608.

At step 608, an activation result is generated by summing the products of the set of products. For example, and with reference to direct activation result calculator 112N of training worker 110N as depicted in FIG. 4 and as described in detail above, activation result generator 416 of multiply/sum module 412 receives set of products 420 from products set generator 414, and sums the products of set of products 420 thereby generating activation result 418.

In the foregoing discussion of steps 602-608 of flowchart 600, it should be understood that at times, such steps may be performed in a different order or even contemporaneously with other steps. Other operational embodiments will be apparent to persons skilled in the relevant art(s). Note also that the foregoing general description of the operation of distributed training system 100 is provided for illustration only, and embodiments of distributed training system 100 may comprise different hardware and/or software, and may operate in manners different than described above. Indeed, steps of flowchart 600 may be performed in various ways.

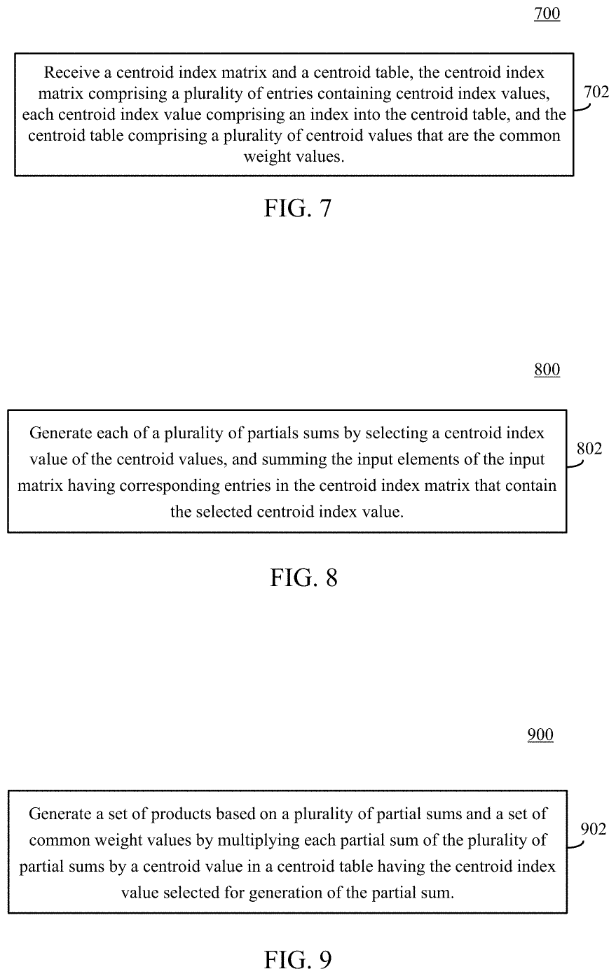

For example, FIG. 7 depicts a flowchart 700 of an additional example method for generating an activation result directly from the compressed representation of a weight matrix, according to an embodiment, and wherein flowchart 700 comprises refinements or additions to the method steps of flowchart 600 as depicted in FIG. 6. Accordingly, flowchart 700 of FIG. 7 is described with continued reference to parameter server 102 of FIG. 1, and training worker 110N, gather/reduce/add module 406, products set generator 414 and activation result generator 416 of FIG. 4. However, other structural and operational embodiments will be apparent to persons skilled in the relevant art(s) based on the following discussion regarding flowchart 700.

Flowchart 700 begins at step 702. At step 702, a centroid index matrix and a centroid table is received, the centroid index matrix comprising a plurality of entries containing centroid index values, each centroid index value comprising an index into the centroid table, and the centroid table comprising a plurality of centroid values that are the common weight values. For example, and with reference to training worker 110N as depicted in FIG. 4 and described above, direct activation result calculator 112N of training worker 110N is configured to accept training data and compressed weight matrices 106N from parameter server 102 via communication interface 208 of weight compressor 104. As described above, training data and compressed weight matrices 106N includes compressed representation 212. As described in detail above, compressed representation 212 may comprise centroid index matrix 304 and centroid table 306 as depicted in FIG. 3, in an embodiment. More specifically, as described above, centroid index matrix 304 may comprise a plurality of elements containing centroid index values, wherein each value is an index (or lookup key) to centroid table 306 (i.e., the centroid lookup table that contains the centroid values for each cluster).

Steps of flowcharts 600 and/or 700 may be performed in additional ways. For example, FIG. 8 depicts a flowchart 800 of an additional example method for generating an activation result directly from the compressed representation of a weight matrix, according to an embodiment, and wherein flowchart 800 comprises refinements or additions to the method steps of flowcharts 600 and/or 700 as depicted in FIGS. 6 and 7, respectively. Accordingly, flowchart 800 of FIG. 8 is described with continued reference to parameter server 102 of FIG. 1, and training worker 110N, gather/reduce/add module 406, products set generator 414 and activation result generator 416 of FIG. 4. However, other structural and operational embodiments will be apparent to persons skilled in the relevant art(s) based on the following discussion regarding flowchart 800.

Flowchart 800 begins at step 802. At step 802, each of a plurality of partials sums is generated by selecting a centroid index value of the centroid values, and summing the input elements of the input matrix having corresponding entries in the centroid index matrix that contain the selected centroid index value. For example, and with reference to training worker 110N as depicted in FIG. 4 and described above, direct activation result calculator 112N of training worker 110N is configured to generate partial sums 410 via partial sum generator 408, and pass same to multiply/sum module 412. More specifically, partial sum generator 408 is configured to generate partial sums 410 by summing the elements of training data matrix 404 that correspond to the same centroid value as indicated by corresponding elements of centroid index matrix 304 of compressed representation 212.

Steps of flowcharts 600, 700 and/or 800 may be performed in additional ways. For example, FIG. 9 depicts a flowchart 900 of an additional example method for generating an activation result directly from the compressed representation of a weight matrix, according to an embodiment, and wherein flowchart 900 comprises refinements or additions to the method steps of flowcharts 600, 700 and/or 800 as depicted in FIGS. 6, 7, and 8, respectively. Accordingly, flowchart 900 of FIG. 9 is described with continued reference to parameter server 102 of FIG. 1, and training worker 110N, gather/reduce/add module 406, products set generator 414 and activation result generator 416 of FIG. 4. However, other structural and operational embodiments will be apparent to persons skilled in the relevant art(s) based on the following discussion regarding flowchart 900.

Flowchart 900 begins at step 902. At step 902, a set of products is generated based on a plurality of partial sums and a set of common weight values by multiplying each partial sum of the plurality of partial sums by a centroid value in a centroid table having the centroid index value selected for generation of the partial sum. For example, and with reference to training worker 110N as depicted in FIG. 4 and described above, products set generator 414 of direct activation result calculator 112N is configured to generate set of products 420 by multiplying each of partial sums 410 by its corresponding centroid value in centroid table 306.

As described above, embodiments of distributed training system 100 are configured to train a machine learning model such as a deep neural network (DNN). For example, various machine learning platforms such as Keras or TensorFlow may permit the construction of an untrained machine learning model that may thereafter be trained, with training data. A general description of the construction and training of a DNN machine learning model follows herein below.

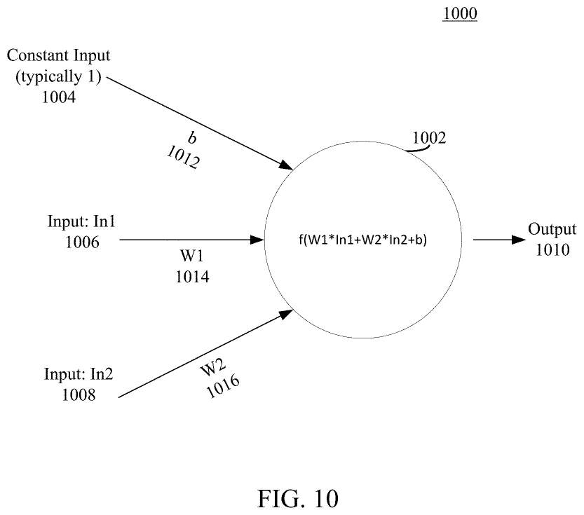

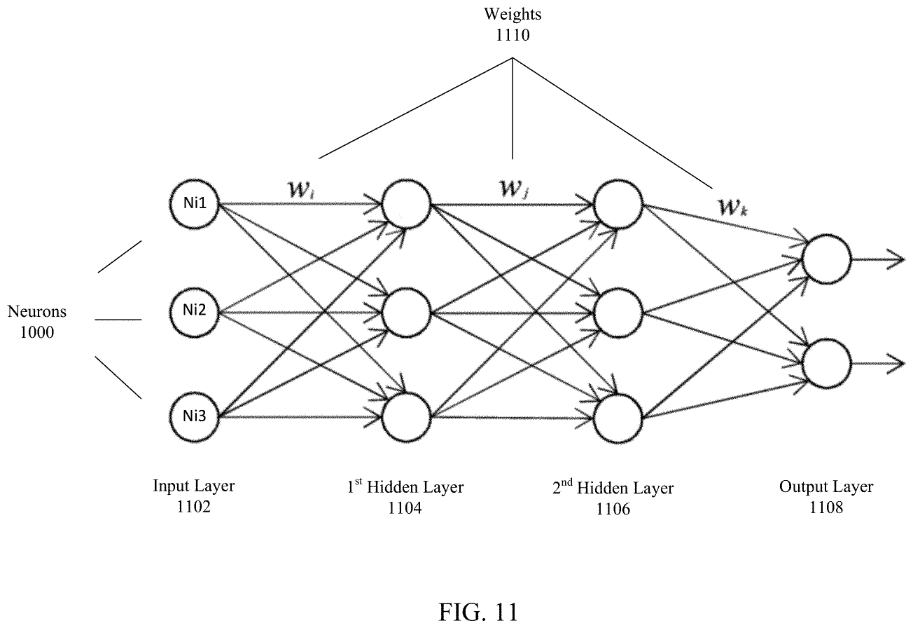

Embodiments may employ various machine learning platforms and algorithms. For example, ONNX models, or other types of machine learning models that may be available or generated, may thereafter be adapted for training by embodiments of distributed training system 100. For example, a deep neural network (“DNN”) may be constructed to perform various image, voice or text recognition tasks. A DNN is a type of artificial neural network that conceptually is comprised of artificial neurons. For example, FIG. 10 depicts an example artificial neuron 1000 suitable for use in a DNN, according to an embodiment. Neuron 1000 includes an activation function 1002, a constant 1004, an input In1 1006, an input In2 1008 and output 1010. Neuron 1000 of FIG. 10 is merely exemplary, and other structural or operational embodiments will be apparent to persons skilled in the relevant art(s) based on the following discussion regarding neuron 1000 of FIG. 10.

Neuron 1000 operates by performing activation function 1002 on weighted versions of constant 1004, In1 1006 and In2 1008 to produce output 1010. Inputs to activation function 1002 are weighted according to weights b 1012, W1 1014 and W2 1016. Inputs In1 1006 and In2 1008 may comprise, for example, normalized or otherwise features processed data corresponding to sensor data 106. Activation function 1002 is configured to accept a single number (i.e., in this example, the linear combination of weighted inputs) based on all inputs, and perform a fixed operation. As known in the art, such operations may comprise, for example, sigmoid, tan h or rectified linear unit operations. Input constant 1004 comprises a constant value typically set to 1, which is then weighted according to bias weight b 1012 allowing activation function 1002 to include a configurable zero crossing point as known in the art.

A single neuron generally will accomplish very little, and a useful machine learning model will require the combined computational effort of a large number of neurons working in concert (e.g., BERT-large with ˜340M parameters). FIG. 11 depicts an example deep neural network (“DNN”) 1100 composed of neurons 1000, according to an embodiment. DNN 1100 includes a plurality of neurons 1000 assembled in layers and connected in a cascading fashion. Such layers include an input layer 1100, a first hidden layer 1104, a second hidden layer 1106 and an output layer 1108. DNN 1100 depicts outputs of each layer of neurons being weighted according to weights 1110, and thereafter serving as inputs solely to neurons in the next layer. It should be understood, however, that other strategies for interconnection of neurons 1000 are possible in other embodiments, and as is known in the art.

The neurons 1000 of input layer 1102 (labeled Ni1, Ni2 and Ni3) each may be configured to accept normalized or otherwise feature engineered or processed data corresponding to sensor data 106 as described above in relation to neuron 1000 of FIG. 10. The output of each neuron 1000 of input layer 1102 is weighted according to the weight of weights 1110 that corresponds to a particular output edge, and is thereafter applied as input at each neuron 1000 of 1^{st} hidden layer 1104. It should be noted that each edge depicted in DNN 1100 corresponds to an independent weight, and labeling of such weights for each edge is omitted for the sake of clarity. In the same fashion, the output of each neuron 1000 of first hidden layer 1104 is weighted according to its corresponding edge weight, and provided as input to a neuron 1000 in 2^{nd} hidden layer 1106. Finally, the output of each neuron 1000 of second hidden layer 1106 is weighted and provided to the inputs of the neurons of output layer 1108. The output or outputs of the neurons 1000 of output layer 1108 comprises the output of the model. In the context of the descriptions above, weight matrix 302 of compressed representation 212 is comprised of weights 1110 Note, although output layer 1108 includes two neurons 1000, embodiments may instead include just a single output neuron 1000, and therefore but a single discrete output. Note also, that DNN 1100 of FIG. 11 depicts a simplified topology, and a producing useful inferences from a DNN like DNN 1100 typically requires far more layers, and far more neurons per layer. Thus, DNN 1100 should be regarded as a simplified example only.

Construction of the above described DNN 1100 comprises only the start of generating a useful machine learning model. The accuracy of the inferences generated by such a DNN require selection of a suitable activation function, and thereafter the each and every one of the weights of the entire model must be adjusted to provide accurate output. The process of adjusting such weights is called “training.” Training a DNN, or other type of neural network, requires a collection of training data of known characteristics. For example, where a DNN is intended to predict the probability that an input image of a piece of fruit is an apple or a pear, the training data would comprise many different images of fruit, and typically including not only apples and pears, but also plums, oranges and other types of fruit. Training requires that the image data corresponding to each image is pre-processed according to normalization and/or feature extraction techniques as known in the art to produce input features for the DNN, and such features are thereafter input to the network. In the example above, such features would be input to the neurons of input layer 1102.

Thereafter, each neuron 1000 of DNN 1100 performs their respective activation function operation, the output of each neuron 1000 is weighted and fed forward to the next layer and so forth until outputs are generated by output layer 1108. The output(s) of the DNN may thereafter be compared to the known or expected value of the output. The output of the DNN may then be compared to the expected value and the difference fed backward through the network to revise the weights contained therein according to a backward propagation algorithm as known in the art. With the model including revised weights, the same image features may again be input to the model (e.g., neurons 1000 of input layer 1102 of DNN 1100 described above), and new output generated. Training comprises iterating the model over the body of training data and updating the weights at each iteration. Once the model output achieves sufficient accuracy (or outputs have otherwise converged and weight changes are having little effect), the model is said to be trained. A trained model may thereafter be used to evaluate arbitrary input data, the nature of which is not known in advance, nor has the model previously considered (e.g., a new picture of a piece of fruit), and output the desired inference (e.g., the probability that the image is that of an apple).

### III. Example Computer System Implementation

Each of parameter server 102, training workers 110A-110N, weight compressor 104, direct activation result calculator 112A-112N, weight compressor 104, weight matrix initializer 202, compressed weight calculator 204, weight matrix updater 206, communication interface 208, gather/reduce/add module 406, partial sum generator 408, multiply/sum module 412, products set generator 414, and/or activation generator 416, and flowcharts 700, 800, 900, and/or 1000 may be implemented in hardware, or hardware combined with software and/or firmware. For example, parameter server 102, training workers 110A-110N, weight compressor 104, direct activation result calculator 112A-112N, weight compressor 104, weight matrix initializer 202, compressed weight calculator 204, weight matrix updater 206, communication interface 208, gather/reduce/add module 406, partial sum generator 408, multiply/sum module 412, products set generator 414, and/or activation generator 416, and flowcharts 700, 800, 900, and/or 1000 may be implemented as computer program code/instructions configured to be executed in one or more processors and stored in a computer readable storage medium. Alternatively, parameter server 102, training workers 110A-110N, weight compressor 104, direct activation result calculator 112A-112N, weight compressor 104, weight matrix initializer 202, compressed weight calculator 204, weight matrix updater 206, communication interface 208, gather/reduce/add module 406, partial sum generator 408, multiply/sum module 412, products set generator 414, and/or activation generator 416, and flowcharts 700, 800, 900, and/or 1000 may be implemented as hardware logic/electrical circuitry.

For instance, in an embodiment, one or more, in any combination, of parameter server 102, training workers 110A-110N, weight compressor 104, direct activation result calculator 112A-112N, weight compressor 104, weight matrix initializer 202, compressed weight calculator 204, weight matrix updater 206, communication interface 208, gather/reduce/add module 406, partial sum generator 408, multiply/sum module 412, products set generator 414, and/or activation generator 416, and flowcharts 700, 800, 900, and/or 1000 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

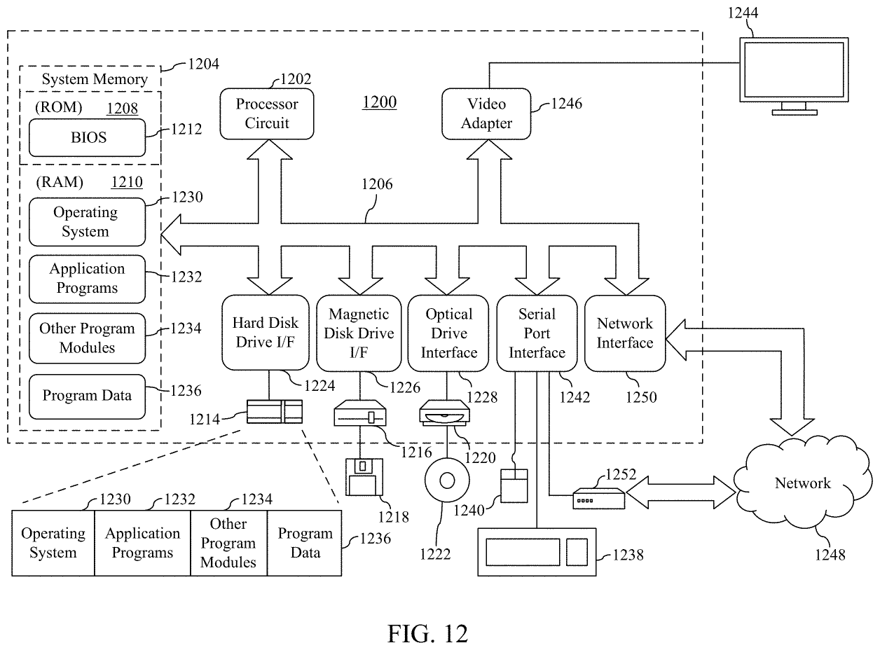

FIG. 12 depicts an exemplary implementation of a computing device 1200 in which embodiments may be implemented. For example, user device 138 and server(s) 140 may be implemented in one or more computing devices similar to computing device 1200 in stationary or mobile computer embodiments, including one or more features of computing device 1200 and/or alternative features. The description of computing device 1200 provided herein is provided for purposes of illustration, and is not intended to be limiting. Embodiments may be implemented in further types of computer systems, as would be known to persons skilled in the relevant art(s).

As shown in FIG. 12, computing device 1200 includes one or more processors, referred to as processor circuit 1202, a system memory 1204, and a bus 1206 that couples various system components including system memory 1204 to processor circuit 1202. Processor circuit 1202 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1202 may execute program code stored in a computer readable medium, such as program code of operating system 1230, application programs 1232, other programs 1234, etc. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computing device 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1230, one or more application programs 1232, other programs 1234, and program data 1236. Application programs 1232 or other programs 1234 may include, for example, computer program logic (e.g., computer program code or instructions) for implementing parameter server 102, training workers 110A-110N, weight compressor 104, direct activation result calculator 112A-112N, weight compressor 104, weight matrix initializer 202, compressed weight calculator 204, weight matrix updater 206, communication interface 208, gather/reduce/add module 406, partial sum generator 408, multiply/sum module 412, products set generator 414, and/or activation generator 416, and flowcharts 700, 800, 900, and/or 1000 (including any suitable step of flowcharts 700, 800, 900, and/or 1000), and/or further embodiments described herein.

A user may enter commands and information into the computing device 1200 through input devices such as keyboard 1238 and pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1202 through a serial port interface 1242 that is coupled to bus 1206, but may be connected by other interfaces, such as a parallel port, game port, or a universal serial bus (USB).

A display screen 1244 is also connected to bus 1206 via an interface, such as a video adapter 1246. Display screen 1244 may be external to, or incorporated in computing device 1200. Display screen 1244 may display information, as well as being a user interface for receiving user commands and/or other information (e.g., by touch, finger gestures, virtual keyboard, etc.). In addition to display screen 1244, computing device 1200 may include other peripheral output devices (not shown) such as speakers and printers.

Computing device 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to refer to physical hardware media such as the hard disk associated with hard disk drive 1214, removable magnetic disk 1218, removable optical disk 1222, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1232 and other programs 1234) may be stored on the hard disk, magnetic disk, optical disk, ROM, RAM, or other hardware storage medium. Such computer programs may also be received via network interface 1250, serial port interface 1242, or any other interface type. Such computer programs, when executed or loaded by an application, enable computing device 1200 to implement features of embodiments described herein. Accordingly, such computer programs represent controllers of the computing device 1200.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A distributed training system for training a deep neural network (“DNN”) including a parameter server and a plurality of training workers configured to iteratively generate global DNN weights until the weights converge is provided herein. In an embodiment, the system comprises: the parameter server configured to: generate a plurality of compressed matrix representations each corresponding to one of a plurality of global weight matrices, wherein each of the plurality of compressed matrix representations comprises a centroid index matrix and a centroid table, each element of the centroid index matrix corresponding to an element of the corresponding one of the plurality of global weight matrices and comprising an index into the centroid table, each element of the centroid table comprising a centroid value; and transfer at least one of the plurality of compressed matrix representations to each of a plurality of training workers.

In another embodiment of the foregoing system, generating the plurality of compressed matrix representations comprises: generating the compressed matrix representations according to a clustering algorithm.

In an embodiment of the foregoing system, the parameter server is further configured to: provide to each training worker of the plurality of training workers at least one input matrix, each training worker calculating gradient matrices directly from the at least one of the plurality of compressed matrix representations based on the at least one input matrix; receive gradient matrices from each of the plurality of training workers; generate updated global weight matrices based at least in part on the received gradient matrices; generate a compressed matrix representation of each updated global weight matrix; and transfer at least one compressed matrix representation of each updated global weight matrix and at least one additional input matrix to each of the plurality of training workers for calculation of gradient matrices thereby.

In one embodiment of the foregoing system, calculating gradient matrices directly from the at least one of the plurality of compressed matrix representations based on the at least one input matrix comprises: generating a plurality of partial sums, each partial sum comprising the sum of the elements of the at least one input matrix that correspond to a common centroid value as indicated by the corresponding elements of the centroid index matrix; generating a set of products by multiplying each partial sum by its corresponding centroid value in the centroid table; and generating an activation result by summing the products of the set of products, the gradient matrices based at least in part on the activation result.

In another embodiment of the foregoing system, the activation result is the input of the next layer of the DNN.

In an embodiment of the foregoing system, the activation result is used to backpropagate a measure of output error of the DNN.

A method for generating an activation result for at least part of a deep neural network (“DNN”) layer is provided herein. The method comprising: receiving a compressed representation of a weight matrix and an input matrix, the input matrix having input elements that are input values to at least part of the DNN layer; generating a plurality of partial sums, each partial sum comprising the sum of input values of the input matrix that correspond to a common weight value of a set of common weight values included in the compressed representation; generating a set of products based on the plurality of partial sums and the set of common weight values; and generating the activation result by summing the products of the set of products.

In an embodiment of the foregoing method, said receiving a compressed representation of a weight matrix and an input matrix comprises: receiving a centroid index matrix and a centroid table, the centroid index matrix comprising a plurality of entries containing centroid index values, each centroid index value comprising an index into the centroid table, and the centroid table comprising a plurality of centroid values that are the common weight values.

In another embodiment of the foregoing method, said generating a plurality of partial sums comprises: generating each partial sum by selecting a centroid index value of the centroid values, and summing the input elements of the input matrix having corresponding entries in the centroid index matrix that contain the selected centroid index value.

In one embodiment of the foregoing method, said generating a set of products based on the plurality of partial sums and the set of common weight values comprises: multiplying each partial sum of the plurality of partial sums by the centroid value in the centroid table having the centroid index value selected for generation of the partial sum.

In an embodiment of the foregoing method, the activation result is the input of the next layer of the DNN.

In another embodiment of the foregoing method, the activation result is used to backpropagate a measure of output error of the DNN.

In one embodiment of the foregoing method, the activation result is used to determine a gradient matrix for the DNN.

A computer program product is provided herein, the computer program product comprising a computer-readable memory device having computer program logic recorded thereon that when executed by at least one processor of a computing device causes the at least one processor to perform operations to generate an activation result for at least part of a deep neural network (“DNN”) layer, the operations comprising: receiving a compressed representation of a weight matrix and an input matrix, the input matrix having input elements that are input values to at least part of the DNN layer; generating a plurality of partial sums, each partial sum comprising the sum of input values of the input matrix that correspond to a common weight value of a set of common weight values included in the compressed representation; generating a set of products based on the plurality of partial sums and the set of common weight values; and generating the activation result by summing the products of the set of products.

In an embodiment of the foregoing computer program product, receiving a compressed representation of a weight matrix and an input matrix comprises: receiving a centroid index matrix and a centroid table, the centroid index matrix comprising a plurality of entries containing centroid index values, each centroid index value comprising an index into the centroid table, and the centroid table comprising a plurality of centroid values that are the common weight values.

In an embodiment of the foregoing computer program product, generating a plurality of partial sums comprises: generating each partial sum by selecting a centroid index value of the centroid values, and summing the input elements of the input matrix having corresponding entries in the centroid index matrix that contain the selected centroid index value.

In an embodiment of the foregoing computer program product, generating a set of products based on the plurality of partial sums and the set of common weight values comprises: multiplying each partial sum of the plurality of partial sums by the centroid value in the centroid table having the centroid index value selected for generation of the partial sum.

In an embodiment of the foregoing computer program product, the activation result is the input of the next layer of the DNN.

In an embodiment of the foregoing computer program product, the activation result is used to backpropagate a measure of output error of the DNN.

In an embodiment of the foregoing computer program product, the activation result is used to determine a gradient matrix for the DNN.

### V. Conclusion

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A distributed training system for training a deep neural network (“DNN”) including a parameter server and a plurality of training workers configured to iteratively generate global DNN weights until the weights converge, the system comprising:
the parameter server configured to:
generate a plurality of compressed matrix representations each corresponding to one of a plurality of global weight matrices, wherein each of the plurality of compressed matrix representations comprises a centroid index matrix and a centroid table, each element of the centroid index matrix corresponding to an element of the corresponding one of the plurality of global weight matrices and comprising an index into the centroid table, each element of the centroid table comprising a centroid value; and
transfer at least one of the plurality of compressed matrix representations to each of a plurality of training workers.

2. The distributed training system of claim 1, wherein said generating the plurality of compressed matrix representations comprises:
generating the compressed matrix representations according to a clustering algorithm.

3. The distributed training system of claim 1, wherein the parameter server is further configured to:
provide to each training worker of the plurality of training workers at least one input matrix, each training worker calculating gradient matrices directly from the at least one of the plurality of compressed matrix representations based on the at least one input matrix;
receive gradient matrices from each of the plurality of training workers;
generate updated global weight matrices based at least in part on the received gradient matrices;
generate a compressed matrix representation of each updated global weight matrix; and
transfer at least one compressed matrix representation of each updated global weight matrix and at least one additional input matrix to each of the plurality of training workers for calculation of gradient matrices thereby.

4. The distributed training system of claim 3, wherein calculating gradient matrices directly from the at least one of the plurality of compressed matrix representations based on the at least one input matrix comprises:
generating a plurality of partial sums, each partial sum comprising the sum of the elements of the at least one input matrix that correspond to a common centroid value as indicated by the corresponding elements of the centroid index matrix;
generating a set of products by multiplying each partial sum by its corresponding centroid value in the centroid table; and
generating an activation result by summing the products of the set of products, the gradient matrices based at least in part on the activation result.

5. The distributed training system of claim 4, wherein the activation result is the input of the next layer of the DNN.

6. The distributed training system of claim 4, wherein the activation result is used to backpropagate a measure of output error of the DNN.

7. A method for generating an activation result for at least part of a deep neural network (“DNN”) layer, comprising:
receiving a compressed representation of a weight matrix and an input matrix, the input matrix having input elements that are input values to at least part of the DNN layer;
generating a plurality of partial sums, each partial sum comprising the sum of input values of the input matrix that correspond to a common weight value of a set of common weight values included in the compressed representation;
generating a set of products based on the plurality of partial sums and the set of common weight values; and
generating the activation result by summing the products of the set of products.

8. The method of claim 7, wherein said receiving a compressed representation of a weight matrix and an input matrix comprises:
receiving a centroid index matrix and a centroid table, the centroid index matrix comprising a plurality of entries containing centroid index values, each centroid index value comprising an index into the centroid table, and the centroid table comprising a plurality of centroid values that are the common weight values.

9. The method of claim 8, wherein said generating a plurality of partial sums comprises:
generating each partial sum by
selecting a centroid index value of the centroid values, and
summing the input elements of the input matrix having corresponding entries in the centroid index matrix that contain the selected centroid index value.

10. The method of claim 9, wherein said generating a set of products based on the plurality of partial sums and the set of common weight values comprises:
multiplying each partial sum of the plurality of partial sums by the centroid value in the centroid table having the centroid index value selected for generation of the partial sum.

11. The method of claim 7, wherein the activation result is the input of the next layer of the DNN.

12. The method of claim 7, wherein the activation result is used to backpropagate a measure of output error of the DNN.

13. The method of claim 7, wherein the activation result is used to determine a gradient matrix for the DNN.

14. A computer-readable memory device having computer program logic recorded thereon that when executed by at least one processor of a computing device causes the at least one processor to perform operations to generate an activation result for at least part of a deep neural network (“DNN”) layer, the operations comprising:
receiving a compressed representation of a weight matrix and an input matrix, the input matrix having input elements that are input values to at least part of the DNN layer;
generating a plurality of partial sums, each partial sum comprising the sum of input values of the input matrix that correspond to a common weight value of a set of common weight values included in the compressed representation;
generating a set of products based on the plurality of partial sums and the set of common weight values; and
generating the activation result by summing the products of the set of products.

15. The computer-readable memory device of claim 14, wherein said receiving a compressed representation of a weight matrix and an input matrix comprises:
receiving a centroid index matrix and a centroid table, the centroid index matrix comprising a plurality of entries containing centroid index values, each centroid index value comprising an index into the centroid table, and the centroid table comprising a plurality of centroid values that are the common weight values.

16. The computer-readable memory device of claim 14, wherein said generating a plurality of partial sums comprises:
generating each partial sum by
selecting a centroid index value of the centroid values, and
summing the input elements of the input matrix having corresponding entries in the centroid index matrix that contain the selected centroid index value.

17. The computer-readable memory device of claim 16, wherein said generating a set of products based on the plurality of partial sums and the set of common weight values comprises:
multiplying each partial sum of the plurality of partial sums by the centroid value in the centroid table having the centroid index value selected for generation of the partial sum.

18. The computer-readable memory device of claim 14, wherein the activation result is the input of the next layer of the DNN.

19. The computer-readable memory device of claim 14, wherein the activation result is used to backpropagate a measure of output error of the DNN.

20. The computer-readable memory device of claim 14, wherein the activation result is used to determine a gradient matrix for the DNN.
